(19) United States
(12) Patent Application Publication
(10) Pub. No.: US 2010/0094771 A1
(43) Pub. Date: Apr. 15, 2010

(54) SYSTEM AND METHOD FOR OPERATING A PRINCIPAL PRESERVATION FUND BASED UPON OPTION COST PER WEEK

(76) Inventor: Geoffrey A. VanderPal, Las Vegas, NV (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/250,797

(22) Filed: Oct. 14, 2008

(51) Int. Cl. G06Q 40/00

(52) U.S. Cl. 705/36 R

(57) ABSTRACT

Disclosed is a system and method for operating an investment account which provides a predetermined level of principle preservation while achieving growth by investing gains from zero or low-risk stable investments into options. In one form, the investment account may be owned by an individual investor or by a number of investors, such as in the form of a mutual fund. In yet another form, business logic may be programmed to automatically select the options based upon their associated premium cost per week until expiration.

### FIELD OF THE INVENTION

The present invention relates to a system and method for operating an investment methodology with the goal of allowing investors to realize gains while preserving their principal investment. More particularly, the present invention relates to an investment account in which a selected portion of principal investments are placed in low risk stable accounts which generate returns which are then invested in other higher risk investments.

### BACKGROUND OF THE INVENTION

A countless number of investment strategies have existed over the years. However, many suffer from the one main drawback in that the principal invested is almost always exposed to loss potential. This can occur, for example, when a stock purchased become worthless or suffers a loss in value. In order to protect against this, cautious investors have often turned to savings accounts, certificates of deposits, and other interest bearing accounts which all offer a small return on investment, usually 1-5% annually, in exchange for the comfort of a guaranteed return. While this is a sound strategy, it often cannot offer the level of return one needs to truly make a financial gain, particularly given the nature of taxation and inflation. As such, a need exists for an investment strategy which offers the best of both worlds in that at least some level of guarantee is provided in the form of principal protection, while the chance for rapid growth also exists.

Options are financial instruments that convey the right, but not the obligation, to engage in a future transaction on some underlying security, or in a futures contract. In other words, the holder does not have to exercise this right, unlike a forward or future contract. For example, buying a call option provides the right to buy a specified quantity of a security at a set strike price at some time on or before expiration in exchange for a premium, while buying a put option provides the right to sell. Upon the option holder's choice to exercise the option, the party who sold, or wrote, the option must fulfill the terms of the contract.

The theoretical value of an option can be determined by a variety of techniques. These models, which are developed by quantitative analysts, can also predict how the value of the option will change in the face of changing conditions. Hence, the risks associated with trading and owning options can be understood and managed with some degree of precision compared to some other investments.

Exchange-traded options form an important class of options which have standardized contract features and trade on public exchanges, facilitating trading among independent parties. Over-the-counter options are traded between private parties, often well-capitalized institutions, that have negotiated separate trading and clearing arrangements with each other.

As such, given the small downside and unlimited upside of investing in options, an investment strategy which combines stable interest bearing accounts with investment of the interest paid into options selected as having a low premium cost per week meets this investment need.

### SUMMARY OF THE INVENTION

In one form a computer implement principal preservation fund is disclosed. The system receives at least one principal investment from an investor and places the funds into one or more stable interest bearing accounts. As interest is paid from the accounts, the derived funds are invested into options selected as having a low premium cost per week and a strike price closely related to the current market price of the underlying security, which extends their value over time. If the options become valuable, they are sold or exercised and the profits re-invested into the stable interest bearing accounts to generate future interest for the purchase of additional options. The fund may have additional investors, to which shares may be issued pro rata in exchange for their investment.

In yet another form, a principal preservation fund administered by a fund manager is disclosed. The fund manager receives at least one principal investment from an investor and places the funds into or purchases with the funds one or more stable interest bearing accounts. As interest is paid from the accounts, the derived funds are invested into options selected by the fund manager using a formula for calculating the cost per week of each available option. If the options become valuable, the fund manager chooses to sell or exercise the option and re-invests the profits into the same or similar stable interest bearing accounts to generate future interest for the purchase of additional options. This form may also allow for a multiple investor fund.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one implementation.

FIG. 2 is a flowchart illustrating the initiation and operation of a fund utilizing the system of FIG. 1.

### DESCRIPTION OF THE SPECIFIC EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Disclosed is a system and method for operating an investment account which provides a predetermined level of principle preservation while achieving growth by investing gains from interest bearing, zero “coupon”, or low-risk stable investments into options. In one form, the fund may be owned by an individual investor or by a number of investors, such as in the form of a mutual fund. For purposes of clarity, only the multi-investor owned form will be described in detail herein, as the individual fund may be operated according to all of the steps provided, with the distinction that it would not require the step of issuing shares to various investors upon investment.

According to the illustrative method for operating a principal preservation mutual fund, an investor receives a specific number of fund shares in return for a cash investment. All or a portion of the fund assets are invested in stable low-risk accounts such as certificates of deposit, money market accounts or the like. As these accounts mature and generate interest, that interest, and potentially a portion of the principal, is invested in options. In one form, the options are selected using a lowest average cost per week formula while seeking options with a strike price close to the market price of the underlying security. The type of options invested in may include index, equity, interest rate, commodities, currency, or the like. Upon the sale of any valuable option, the gain is invested back into the stable low-risk accounts so that it may generate more future interest. In the event that an option is worthless, then at least a portion of the principal investment remains, and only its premium, which is paid from interest on the principal, is lost.

In the preferred form, the lowest cost per week formula calculates an average weekly cost as the Call Option Premium divided by the number of weeks before expiration of the option. As the premium cost per week decreases the potential for growth increases.

In a further embodiment, the method provides for the selection of low-risk stable investment accounts including certificates of deposit based upon the ratings of several recognized ratings agencies, money market accounts, treasury bills, corporate paper, repurchase agreements, bankers acceptances, or the like. Preferably, the accounts selected are either privately or federally insured.

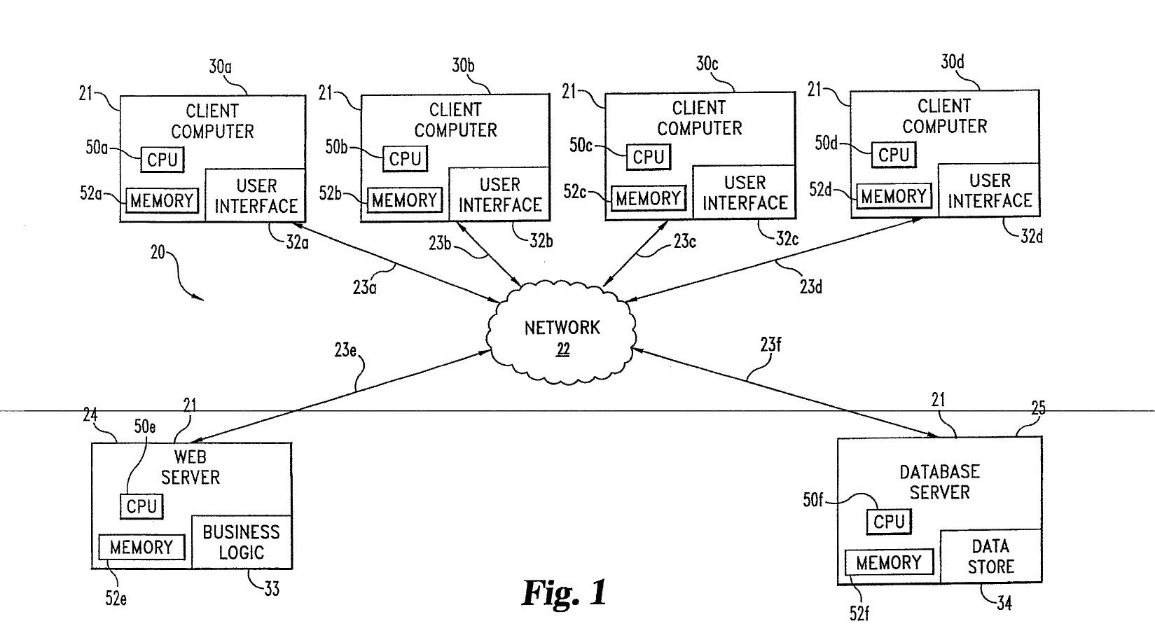

Turning to FIG. 1, a diagrammatic view of a computer system 20 suitable for administration and operation of a principal preservation fund according to one embodiment of the present invention is shown. Computer system 20 includes computer network 22. Computer network 22 couples together a number of computers 21 over network pathways 23a-23d. More specifically, system 20 includes several servers, namely web server 24 and database server 25. System 20 also includes client computers 30a, 30b, 30c, and 30d which may be located at geographically distinct locations. While computers 21 are each illustrated as being a server or client, it should be understood that any of computers 21 may be arranged to include both a server and one or more client computers. Furthermore, it should be understood that while six computers 21 are illustrated, more or fewer may be utilized in alternative embodiments. In particular, it shall be appreciated that a large number of client computers, such as client computers 30, may be in use within system 20 for performing operations such as allowing numerous individual users to connect to web server 24.

Turning to implementation specifics, in the illustrative embodiment, computers 21 include one or more processors or CPUs (50a, 50b, 50c and 50d respectively) and one or more types of memory (52a, 52b, 52c and 52d respectively). Each memory 52a-d preferably includes a removable memory device. Each processor 50a-50d may be comprised of one or more components configured as a single unit. Alternatively, when of a multi-component form, a processor 50a-50d may have one or more components located remotely relative to the others. One or more components of each processor 50a-50d may be of the electronic variety defining digital circuitry, analog circuitry, or both. In one embodiment, each processor 50a-50d is of a conventional, integrated circuit microprocessor arrangement, such as one or more PENTIUM 4 or XEON processors supplied by INTEL Corporation of 2200 Mission College Boulevard, Santa Clara, Calif. 95052, USA.

Although not shown, in one embodiment each computer 21 is coupled to a display and/or includes an integrated display. Computers 21 may be of the same type, or a heterogeneous combination of different computing devices. Likewise, displays may be of the same type, or a heterogeneous combination of different visual devices. Although not shown, each computer 21 may also include one or more operator input devices such as a keyboard or mouse to name just a few representative examples.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. In a further form, several computers 21, such as web server 24 and database server 25 may be coupled together by a secure portion of network 22 while remaining connected to client computer 30 via an unsecured portion of network 22. Client computers 30 preferably connect to web server 24 via an encrypted communication channel, such as SSL, TLS, or the like. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations where web server 24 is configured to host application business logic 33 for a principal preservation fund, data store 34 of database server 25 is configured to store fund information, including the current allocation of fund assets, fund shareholders, and current market information, and client computer 30 is configured for providing a user interface 32, for allowing a user to interact with the fund, such as to monitor its status, input purchasing decisions, or purchase/sell shares. It shall be appreciated that in alternate forms client computer 30 may be any web-enabled device, such as a PDA, Blackberry, or mobile phone, to name just a few illustrative examples. Furthermore, user interface 32 of client computer 30 may be an installable application such as one that communicates with web server 24, browser-based, and/or embedded software, to name a few non-limiting examples. In one embodiment, software installed locally on client computers 30 is used to communicate with web server 24. In another embodiment, web server 24 provides HTML pages, data from web services, and/or other Internet standard or company proprietary data formats to one or more client computers 30 when requested. One of ordinary skill in the art will recognize that the term web server 24 is used generically for purposes of illustration and is not meant to imply that network 22 is required to be the Internet.

Typical applications of system 20 would include two centrally located servers, such as web server 24 and database server 25, but it will be appreciated by those of ordinary skill in the art that the one or more features provided by those servers could be provided by a single computer or varying other arrangements of computers at one or more physical locations and still be within the spirit of the invention.

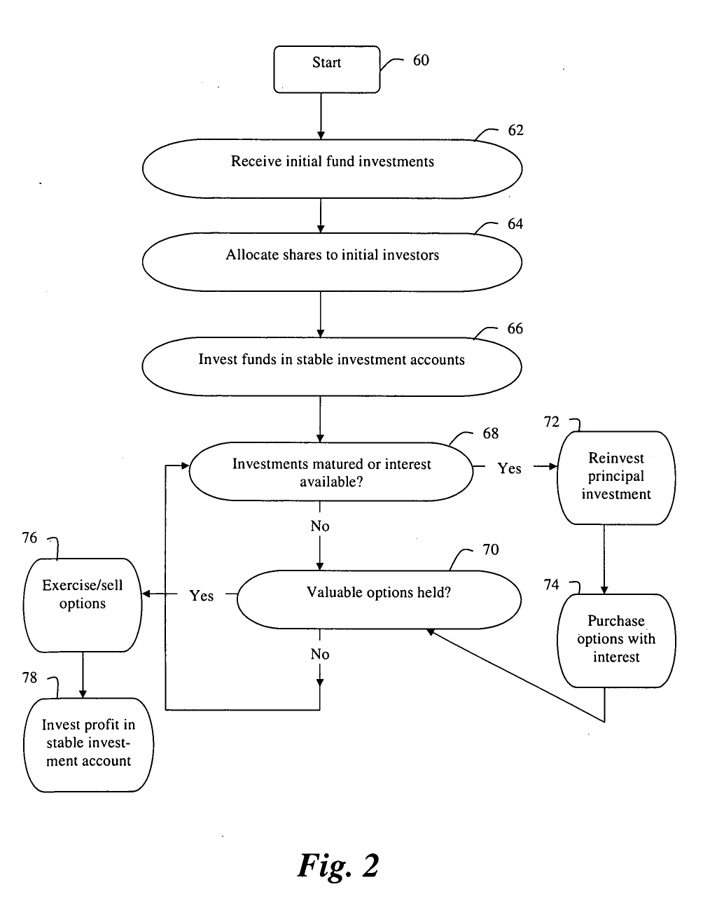

Turning to FIG. 2, with continued reference to FIG. 1, the stages involved in operating a principal preservation fund using the system of FIG. 1 according to the illustrative embodiment are shown in flowchart form. The process begins at start point 60 with business logic 33 receiving a notification evidencing that the initial fund investments have been received (stage 62) and are available for investment. This notification, or series of notifications, may be received in the form of a statement or wire transfer acknowledgement received from an online banking institution or the like, or alternatively may be input by a user, such as a fund administrator using one of client computers 30. Business logic 33 interfaces with database server 25 to record the current balance of fund assets in data store 34 so that future investment decisions may be made.

In response to each notification, business logic 33 allocates the appropriate number of shares to the individual or entity responsible for the underlying investment (stage 64). For example, an initial investment of $5,000 may represent 5 shares, depending upon the initial par value selected by the fund administrator. The selected par value, number of shares, and the individuals or entities to which they are allocated are both recorded in an ownership information table stored in data store 34 by database server 25. In further forms, transferable certificates or the like may be issued to the fund shareholders evidencing their ownership interest.

Once notified of the availability of the funds, business logic 33 receives a notification that the funds have been invested in stable investment accounts (stage 66). In the illustrative form, the entire balance of the fund is invested into an investment account. However, in an alternate form, only a predetermined percentage is invested into stable investment accounts, such as 95%, 90%, or some other amount, so as to allow some other investment of the principal to take place which will be discussed later.

The type of accounts contemplated by stable investment account includes, but is in now way limited to, saving accounts, money market accounts, certificate of deposit accounts, banker's acceptances, U.S. Treasure bills, commercial paper, repurchase agreements, and other interest bearing accounts or the like which maintain the value of the principal investment. The accounts selected may be located either within the United States or internationally, however, international accounts based in foreign currency introduce potential risks to the principal investment due to fluctuation in currency exchange rates. Preferably, the accounts selected are either federally or privately insured, such as by the Federal Deposit Insurance Corporation (FDIC), and are rated in either the top one or two categories by a recognized rating agents, such as S&P or Moody's. In one form, the notification may be received as confirmation of investment by a fund administrator. In an alternate form, the funds may be automatically invested in a set of designated investment accounts according to predetermined criteria. Once invested, the account number, banking institution, balance, interest rate, maturity date (if applicable), and other relevant details of each account are stored in data store 34 of database server 25 in association with the proper fund.

Once the investments are made, business logic 33 begins actively monitoring the investment accounts for the first available maturing investment account or periodic disbursement of interest (stage 68). In the event that there is interest available from a certificate of deposit account or other maturing account the principal investment from that account is reinvested in a stable investment account, as described with respect to stage 66 (stage 72) and the interest is maintained by the fund in a profit collection account. In the case of other accounts, such as money market accounts, the interest credited is simply withdrawn from the investment account and placed into the profit collection fund for use by the fund in purchasing options, while the principal investment remains to generate additional interest for future use.

Once funds are available in the profit collection account, business logic 33 notifies the fund manager so that options may be purchased. In an alternate form, an option selection algorithm is initiated by the business logic 33. According to the illustrative embodiment, either the fund manager or the option selection algorithm collects current information regarding the premiums for purchasing various options. The options considered may include exchange traded options (often known as “listed options”), which are standardized options available through a clearinghouse, and over the counter options (know as “dealer options”) which are unrestricted and exchanged between two parties. For purposes of illustration, the types of options considered includes, but is by no means limited to, stock options, commodity options, bond options, interest rate options, index options, options on future contracts, currency options, and swap options. These options may be considered and purchased in a European, American, Bermudian, Barrier, Asian, Rainbow, Flex and LEAPs style.

In selecting options for purchase, either the option selection algorithm or the fund administrator calculates the average premium cost per week for each available option. The average premium cost per week is calculated as the actual premium price divided by the number of weeks until the expiration date. For example, if an option has a premium of $100 and expires in 5 weeks, then the cost per week is $20. Prior to being selected as an available option contract, the fund manager or selection algorithm may require that the option meet a selected set of criteria, such as the capitalization of the issuer, closely matching strike price with underlying security or index market value, or the like. Once the various cost per week figures are calculated for each available option, a set of options are selected for purchase (stage 74). The fund manager or the business logic 33 may initiate the purchases and business logic 33 receives a notification of their completion. In one form, various quantities of the available options are designated for purchase, while in another form, the algorithm or fund manager seeks to diversify amongst the available options have the lowest cost per week premiums. Preferably, as much of the profit collection account as possible is invested in options. Additionally, in a further form, a combination of diversification and the quantity associated with the options purchased may be selected. Once purchased and acknowledged, business logic 33 stores various information, such as cost, expiry, type, etc. regarding each option purchased in data store 34 of database server 25 so that the options held by the fund may be monitored and evaluated.

In an alternate embodiment, the fund may be allowed to invest a predetermined percentage of the principal investment in options. For instance, the fund may be allowed to risk 5% or 10% of the principal investment into selected options in order to seek more aggressive growth with this specified level of risk tolerance. The fund may require makeup in the event that any portion of the principal investment is lost prior to further investing of the interest income, or the fund may simply prevent the balance of stable asset accounts from ever going below a set percentage of their initial value.

Once options have been purchased with either fund assets or interest earned from the investment of those assets, depending upon whether any risk tolerance is selected, the process continues with business logic 33 utilizing data store 34 of database server 25 to monitor the current value of the options owned. Business logic 33 periodically determines if any of the options held by the fund have value (step 70). This is known as an option being “in-the-money” and occurs when the strike price of the underlying commodity is favorable compared to its current market price, known as the spot price. In the event of a call option, this means that the spot price is above the strike price and vice versa in the case of a put option. Once business logic 33 determines that an option held by the fund is “in the money”, the fund may decide to exercise or sell the option (stage 76). In the event of an American style option, as opposed to a European style, the fund may chose to exercise the option in advance of its expiration. However, the fund may also choose to sell the option otherwise in order to realize any gains (stage 78). In addition, the fund may choose to hold the option in anticipation of further gains. Business logic 33 is programmed to make this decision in one form, while in another form it may be made by the fund manager. Once the option is sold for value, the profit is invested into a stable investment account so that the principal investment will grow and the amount of interest generated will similarly rise, provided rates remains the same, allowing the fund more purchasing power with respect to investment options in the future.

The fund continues along the path between stages 68-74 periodically until all of the assets are withdrawn by the investors, as there is no risk of the fund ever becoming worthless due to its principal preserving properties. In the event additional investors are taken, they may be allocated shares in exchange for their investment based upon the current valuation of the fund and the number of outstanding shares.

While the invention has been illustrated and described in detail in the drawings and foregoing description, the same is to be considered as illustrative and not restrictive in character. Only the preferred embodiment, and certain alternative embodiments deemed useful for further illuminating the preferred embodiment, have been shown and described. All changes and modifications that come within the spirit of the invention are desired to be protected.

What is claimed is:

1. A method for operating a principal preservation fund comprising the steps of:
receiving a principal cash investment from at least a first investor;
investing said principal cash investment into a first set of stable interest bearing accounts to generate a first return;
calculating a first value indicating the premium cost per week prior to expiration for each of a plurality of options;
calculating a second value indicating the proximity of the strike price to the spot price of the underlying instrument for at least a subset of said plurality of options;
selecting at least one option from said plurality of options based upon said first value and said second value;
purchasing said at least one option using said first return;
disposing of said at least one option to generate a second return; and
investing said second return into a second set of stable interest bearing accounts.

2. The method of claim 1, wherein said disposing step consists of selling said at least one option.

3. The method of claim 1, wherein said disposing step consists of exercising said at least one option.

4. The method of claim 3, wherein said at least one option is exercised in exchange for a cash value.

5. The method of claim 3, wherein said at least one option is exercised and the underlying instrument is sold.

6. The method of claim 1, further comprising the step of:
issuing a number of shares to said first investor based upon the amount of said investment and the current value of said fund at said receiving step.

7. The method of claim 6, wherein the principal preservation fund is operated under the guidelines of the Investment Company Act of 1940.

8. The method of claim 1, wherein said at least one option is selected from said subset of said plurality of options.

9. The method of claim 1, wherein each account within said first set is an insured account.

10. The method of claim 8, wherein each account within said first set is insured by the Federal Deposit Insurance Corporation.

11. The method of claim 1, wherein at least one account within said first set is a certificate of deposit account.

12. The method of claim 1, wherein at least one account within said first set is a money market account.

13. The method of claim 1, wherein at least one account within said first set is in the form of a bankers acceptance.

14. The method of claim 1, wherein at least one account within said first set is in the form of commercial paper.

15. The method of claim 1, wherein said first stable interest bearing account is an international account.

16. The method of claim 1, wherein said first values and said second values are calculated by a computer implemented algorithm.

17. The method of claim 1, wherein at least one account within said first set of accounts is also within said second set of accounts.

18. A method for operating a principal preservation fund having a stated preservation percentage comprising the steps of:
receiving a principal cash investment from at least a first investor;
investing at least said stated preservation percentage of said principal cash investment into a first set of stable interest bearing accounts to generate a first return;
establishing an reserve account including a portion of said principal cash investment and said first return;
selecting at least one option from said plurality of options based upon a plurality of criteria;
purchasing said at least one option using funds from said reserve account;
disposing of said at least one option to generate a second return; and
placing said second return into said reserve account or a second set of stable interest bearing accounts depending upon the balance of said first set of accounts and said stated preservation percentage.

19. The method of claim 18 further comprising the steps of:
calculating a first value indicating the premium cost per week prior to expiration for each of a plurality of options; and
calculating a second value indicating the proximity of the strike price to the spot price of the underlying instrument for at least a subset of said plurality of options prior to said selecting step.

20. The method of claim 19, wherein said plurality of criteria includes said first value and said second value.

21. The method of claim 18, wherein said stated preservation percentage is at or above 50%.

22. The method of claim 21, wherein said stated preservation percentage is at or above 75%.

23. The method of claim 18, wherein said stated preservation percentage is at or above 90%.

24. The method of claim 18, wherein said stated preservation percentage is at or above 95%.
